(19) United States
(12) Patent Application Publication
(10) Pub. No.: US 2026/0259343 A1
(43) Pub. Date: Sep. 3, 2026

(54) LOOK-AHEAD VSP ELASTIC WAVEFORM INVERSION

(71) Applicant: SCHLUMBERGER TECHNOLOGY CORPORATION, Sugar Land, TX (US)

(72) Inventors: Yu CHEN, Sugar Land, TX (US); Takashi MIZUNO, Sugar Land, TX (US)

(21) Appl. No.: 19/521,377

(22) PCT Filed: Nov. 5, 2024
(86) PCT No.: PCT/US2024/054539

§ 371 Date: Mar. 20, 2026

Related U.S. Application Data
(60) Provisional application No. 63/597,121, filed on Nov. 8, 2023.

(51) Int. Cl. G01V 1/50; E21B 49/00

(52) U.S. Cl. CPC G01V 1/50; E21B 49/00; E21B 2200/20; G01V 2210/161; G01V 2210/6222; G01V 2210/6224

(57) ABSTRACT

Systems and methods for processing vertical seismic profile (VSP) data based on an elastic waveform inversion (EWI). The EWI uses P-wave or S-wave velocity and density information above a total depth of a well and the VSP data to invert parameters including a one dimensional (ID) depth, P-wave or S-wave velocity, density, and attenuation below the total depth. The EWI includes computing a template reflection and searching potential reflections using a cross-correlation between the template reflection and the VSP data. The EWI includes a grid search used to invert the parameters for each subsurface layer below the total depth and a fine-tuning to optimize the inverted parameters based on a downhill simplex method.

### CROSS-REFERENCE TO RELATED APPLICATION

This application claims the benefit of U.S. Provisional Application No. 63/597,121, filed on Nov. 8, 2023.

### BACKGROUND INFORMATION

This disclosure relates to systems and methods for seismic data processing based on an elastic waveform inversion. More specifically, aspects of the disclosure provide for using an elastic waveform inversion based data processing system to process vertical seismic profile data.

Look-ahead Vertical Seismic Profile (VSP) is a borehole seismic survey used to measure one dimensional (1D) seismic velocities (e.g., P-wave or S-wave velocities) of subsurface layers (e.g., rock layers) beneath a wellbore. The look-ahead VSP may be used to detect seismic property changes while drilling, resulting in higher resolution images of the subsurface layers (e.g., compared to surface seismic images) for looking ahead of a drill operation. Acoustic impedance inversion is often used in VSP data to obtain the seismic property changes between interfaces of the subsurface layers. However, inversion results based on the acoustic impedance inversion, such as the density and velocity of the subsurface layers, are coupled together. Moreover, the inversion results are in time, which may make it difficult for an operator to follow in terms of spatial relationships to other features of the well.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a system for seismic data processing based on an elastic waveform inversion includes a memory configured to store at least a template-based search algorithm, a grid search algorithm, and a downhill simplex algorithm. The system also includes one or more processors configured to receive input models associated with a subsurface layer above a total depth of a well, calculate a reflection template based at least in part on the input models, receive vertical seismic profile (VSP) data acquired at the well, employ the template-based searching algorithm to detect multiple reflections below the total depth of the well and associated with the subsurface layer and multiple subsequent subsurface layers below the subsurface layer, employ the grid search algorithm to determine a depth of the subsurface layer and a set of parameters associated with the subsequent subsurface layers based on the reflections, employ the downhill simplex algorithm to invert the set of parameters for the subsequent subsurface layers simultaneously, and generate output models including the set of parameters being inverted.

In one non-limiting embodiment, a method for seismic data processing based on an elastic waveform inversion includes receiving input models associated with a subsurface layer above a total depth of a well, calculating a reflection template based at least in part on the input models, receiving vertical seismic profile (VSP) data acquired at the well, determining a number and polarities of multiple reflections below the total depth of the well and associated with the subsurface layer and multiple subsequent subsurface layers below the subsurface layer based on the vertical seismic profile (VSP) data and the reflection template, determining a depth of the subsurface layer and a set of parameters associated with the subsequent subsurface layers based on the reflections, inverting the set of parameters for the subsequent subsurface layers simultaneously, and generating output models comprising the set of parameters being inverted.

In one non-limiting embodiment, a non-transitory computer-readable medium includes instructions that, when executed by one or more processors, cause the one or more processors to receive input models associated with a subsurface layer above a total depth of a well, calculate a reflection template based at least in part on the input models, receive vertical seismic profile (VSP) data acquired at the well, detect multiple reflections below the total depth of the well and associated with the subsurface layer and multiple subsequent subsurface layers below the subsurface layer, determine a number and polarities of the reflections based on the vertical seismic profile (VSP) data and the reflection template, determine a depth of the subsurface layer and a set of parameters associated with the subsequent subsurface layers based on the reflections, invert the set of parameters for the subsequent subsurface layers simultaneously, and generate output models comprising the set of parameters being inverted.

### BRIEF DESCRIPTION OF THE DRAWINGS

Various aspects of this disclosure may be better understood upon reading the following detailed description and upon reference to the drawings, in which:

FIG. 1 depicts a schematic diagram of a vertical seismic profile (VSP) survey and an elastic waveform inversion (EWI) based data processing system, in accordance with embodiments of the present disclosure;

FIG. 2 depicts a flow diagram of an EWI workflow for processing VSP data acquired in the VSP survey using the EWI-based data processing system of FIG. 1, in accordance with embodiments of the present disclosure;

FIG. 3 depicts an example reflection search process used in the EWI workflow of FIG. 2 based on cross-correlations between template reflection waveforms and VSP data waveforms, in accordance with embodiments of the present disclosure;

FIG. 4 depicts a schematic diagram of a multi-layer subsurface structure that may be used to illustrating an example parameter inversion process used in the EWI workflow of FIG. 2, in accordance with embodiments of the present disclosure; and

FIG. 5 depicts examples of inversion results using the EWI workflow of FIG. 2, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first”, “second” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In geophysics (e.g., oil and gas exploration or development), vertical seismic profile (VSP) is a technique of seismic measurements that may be used for correlation with surface seismic data. A characteristic of the VSP is that an energy source (e.g., dynamite, air-gun, vibroseis), or detectors (e.g., hydrophones, geophones, or accelerometers), or both, are placed in a borehole. The detectors may detect seismic energy originating from the seismic source and reflected by subsurface layers, generating VSP data.

There are numerous methods for acquiring the VSP data. The VSP data may include zero-offset, near-offset, mid-offset, and far-offset VSP data. For example, zero-offset VSP is a type of VSP survey in which the energy source is positioned close to a wellbore and directly above detectors disposed inside a borehole. The VSP data may provide borehole seismic measurements used for correlation with surface seismic data and obtaining subsurface images (e.g., images of subsurface rock layers) with higher resolution than surface seismic images, which may provide for looking ahead of drill operations.

Various look-ahead VSP inversion approaches have been applied to VSP survey, such as acoustic impedance inversion, one dimensional elastic waveform inversion (1D EWI), two dimensional waveform inversions (2D EWI), and three dimensional waveform inversions (3D EWI) for VSP data. However, such approaches have certain limitations. For example, certain 2D/3D EWIs parameterize the space into grid with a size, while the VSP processing defines layers with various depths. Moreover, certain 2D/3D EWIs use smoothing or regularization of the grids, which may reduce the depth resolution of an interface (e.g., interface between two adjacent subsurface layers). Furthermore, computation time of existing EWI approaches does not meet requirements for often needed rush processing time of VSP data. Additionally, existing EWI approaches assume a precise initial model being used. However, the precise initial model may not be available prior to processing of the VSP data.

The embodiments of the present disclosure provide systems and methods to alleviate the limitations associated with the existing approaches described above. For example, an elastic waveform inversion (EWI) based data processing system may include an EWI workflow for processing VSP data, which may supplement or replace current standard look ahead VSP processing workflow(s). The EWI workflow may be applied to seismic data while drilling or during a postprocessing. The EWI-based data processing system may use algorithms based on viscoelastic waveform inversion above a total depth (TD) of a wellbore to invert a one dimensional (1D) depth, P-wave velocity (V_{P}) or S-wave velocity (V_{S}), density, and attenuation below the TD. For example, the EWI-based data processing system may use an algorithm to compute a template reflection and search potential reflections using cross-correlation of the template reflection. The algorithm may include two steps in a model parameter inversion. First, a grid search is used to invert parameters, such as 1D depth, V_{P}, density, and attenuation for each subsurface layer. Second, the inverted parameters are further fine-tuned by using a downhill simplex method.

The EWI-based data processing system in present disclosure may provide certain advantages over the existing EWI approaches. For example, the model parameterization is consistent with VSP defining depth, velocity and other parameters in each subsurface layer. Moreover, a limited number (e.g., 3, 5, or 10) of subsurface layers are inverted without using smoothing or regularization, such as the depth of each interface between two adjacent subsurface layers only depends on time of a reflection occurring on a respective interface and the velocity above the respective interface. Further, computational time may be reduced (e.g., to a few seconds or minutes) with the fast grid search and downhill simplex optimization. Additionally, no initial model and a priori information (e.g., subsurface layer properties) are needed.

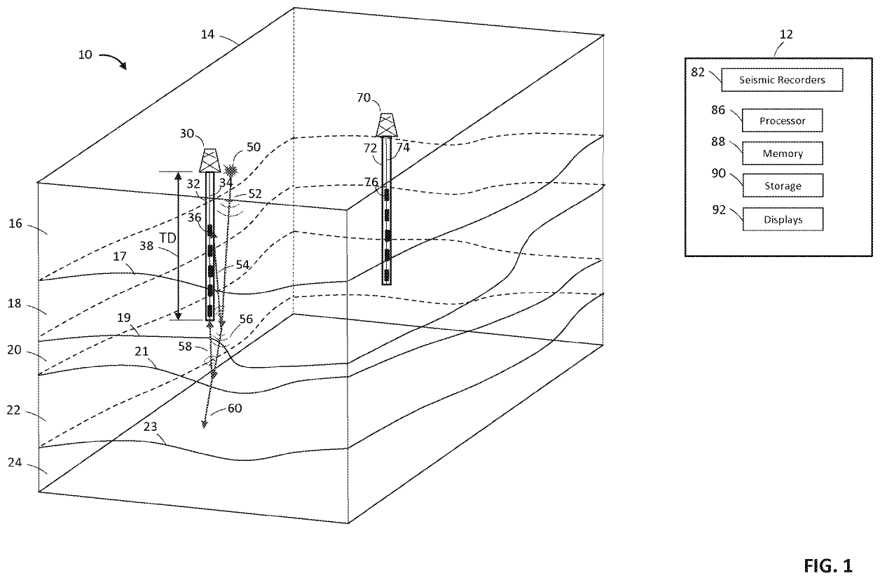

With the proceeding in mind, FIG. 1 depicts a schematic diagram of a vertical seismic profile (VSP) survey 10 and an elastic waveform inversion (EWI) based data processing system 12. By conducting the VSP survey 10 in an area 14, VSP data may be recorded and further processed by the EWI-based data processing system 12.

The area 14 may include multiple subsurface layers, such as layers 16, 18, 20, and 22. Each layer may represent a geological structure having specific properties, such as depth, velocities (e.g., P-wave and S-wave velocities), density, attenuation and so on. Interfaces between adjacent layers, such as interfaces 17 (between layers 16 and 18), 19 (between layers 18 and 20), 21 (between layers 20 and 22), and 23 (between layers 22 and 24) are used to define corresponding boundaries between the adjacent layers. Certain geological formations embedded in some of the subsurface layers may contain hydrocarbon deposits. Seismic data (e.g., VSP data) acquired in the VSP survey 10 may be used to derive various properties (e.g., depths, P-wave and/or S-wave velocities, densities, attenuation) of the subsurface layers, which may be used to generate subsurface images (e.g., by combining with surface seismic data) indicative of the hydrocarbon deposits.

The VSP survey 10 may include vertical seismic profile (VSP) measurement by employing seismic sensors or receivers (e.g., hydrophones, geophones, accelerometers, fiber-optic sensors, or hybrid sensors) in one or more wells (e.g., wells 30 and 70). For example, one set of seismic sensors 36 may be disposed along a wireline cable 34 deployed in a borehole 32 of the well 30, which may be drilled through the layers 16 and 18 and ended at the interface 19. A total depth (TD) 38 is used to define a downward length of the well 30. Some subsurface layers, such as the layers 16 and 18, locate above the TD 38. Other subsurface layers, such as the layers 20 and 22, locate below the TD 38. Similarly, a different set of seismic sensors 76 may be disposed along a wireline cable 74 deployed in a borehole 72 the well 70, which may be drilled in a different location of the area 14. The seismic sensor 36 and 76 may measure ground motions (e.g., particle movements such as velocity and acceleration) and/or other properties related to the ground motions (e.g., strains) caused by reflected or refracted seismic waves traveling through the layers 16, 18, 20, and 22.

During the VSP survey 10, a seismic source 50 may be activated to generate seismic waves 52 traveling downward into the subsurface layers. For the VSP, the seismic source 50 is positioned close to a wellbore of the well 30 and directly above the seismic sensors 36 disposed inside the borehole 32. When the seismic waves 52 arrives at the interface 19 between the layers 18 and 20, a portion of seismic energy contained in the seismic waves 52 is reflected by the interface 19. Reflected waves 54 travel upward and arrive at the seismic sensors 36, where they are measured by the seismic sensors 36. Another portion of the seismic energy contained in transmitted seismic waves 56 propagated through the layer 20 and arrives at the interface 21 between the layers 20 and 22. A portion of seismic energy contained in the transmitted waves 56 is reflected by the interface 21. Reflected waves 58 travel upward and arrive at the seismic sensors 36, where they are measured by the seismic sensors 36. The rest of the seismic energy contained in transmitted seismic waves 60 continuously propagated through deeper subface layers (e.g., layer 22).

It should be noted that the elements described above with regard to the VSP survey 10 are provided by way of example. For instance, some embodiments of the VSP survey 10 may include additional or fewer elements than those shown. In some embodiments, the VSP survey 10 may combine with other seismic surveys (e.g., surface seismic surveys, ocean bottom node surveys) conducted in the area 14.

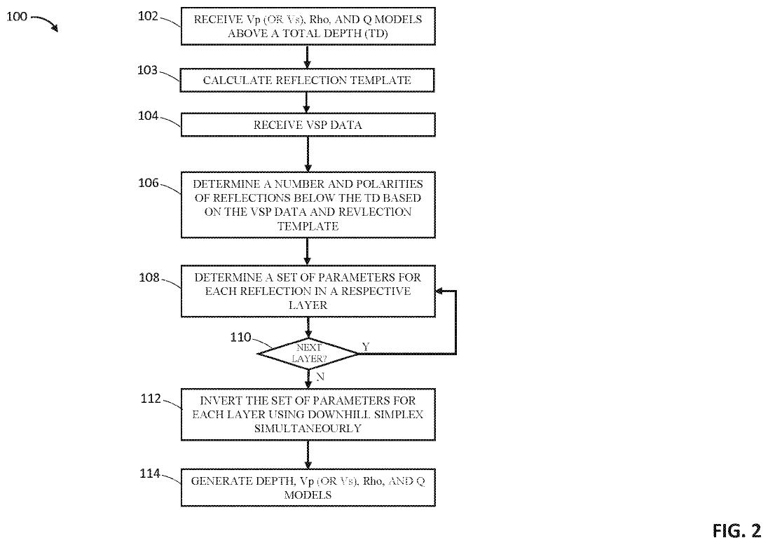

The VSP data acquired from different sensors (e.g., seismic sensor 36 and 76) may be collected and processed by the EWI-based data processing system 12. The EWI-based data processing system 12 may include one or more seismic recorders 82, one or more processors 86, a memory 88, a storage 90, and one or more displays 92. The one or more seismic recorders 82 may receive the VSP data from seismic sensor 36 and 76 employed in the wells 30 and 70. The VSP data may be processed by the one or more processors 86 using processor-executable code (e.g., code for implementing the EWI algorithms) stored in the memory 88 and the storage 90. The processed data may be stored in the storage 90 for later usage (e.g., postprocessing). Processing results may be displayed via the one or more displays 92. Data processing based on the VSP data will be discussed in detail below with reference to FIG. 2.

In one embodiment, the EWI-based data processing system 12 may be implemented in an on-site data center in the area 14. In another embodiment, the EWI-based data processing system 12 may be implemented in an offsite data center away from the area 14.

The one or more processors 86 may be any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, memory 88, storage 90, and one or more displays 92).

The memory 88 and the storage 90 may be any suitable articles of manufacture that can serve as media to store processor-executable code, data, or the like. These articles of manufacture may represent computer-readable media (e.g., any suitable form of memory or storage) that may store the processor-executable code used by the one or more processors 86 to perform the presently disclosed techniques. The memory 88 and the storage 90 may also be used to store the VSP data, reflection templates, subface layer parameters or models, and inversion data (e.g., depths, velocities, and densities). Additionally, the memory 88 and the storage 90 may also be used to store various other software applications for seismic data analysis and data processing. The memory 88 and the storage 90 may represent non-transitory computer-readable media (e.g., any suitable form of memory or storage) that may store the processor-executable code used by the one or more processors 86 to perform various techniques described herein. It should be noted that non-transitory merely indicates that the media is tangible and not a signal.

The one or more displays 92 may operate to depict visualizations associated with software or executable code being processed by the one or more processors 86. The one or more displays 92 may be any suitable type of display, such as a liquid crystal display (LCD), plasma display, or an organic light emitting diode (OLED) display.

It should be noted that the components described above with regard to the EWI-based data processing system 12 are exemplary components and the EWI-based data processing system 12 may include additional or fewer components as shown. For example, the EWI-based data processing system 12 may include one or more communication interfaces to send commands to different seismic acquisition systems (e.g., for acquiring the VSP data in different wells such as the wells 30 and 70) and receive measurement from the different seismic acquisition systems. In some embodiments, the EWI-based data processing system 12 may include an interrogator that includes a light source for providing source light signals (e.g., laser impulses) for fiber-optic sensors.

With these in mind, FIG. 2 depicts a flow diagram of an EWI workflow 100 for processing VSP data acquired in the VSP survey 10 using the EWI-based data processing system 12 of FIG. 1. Although the method described in FIG. 2 is described in a particular order and as being performed by a particular component, it should be understood that the method may be performed in any suitable order and by any suitable computing device or application.

Referring now to FIG. 2, at process block 102, a processor (e.g., the processor 86) of the EWI-based data processing system 12 may receive an input P-wave velocity (V_{P}) or S-wave velocity (V_{S}) model, an input density (Rho) model, and an input attenuation (Q) model above a total depth (TD) of a well (e.g., the TD 38 of the well 30). The input V_{P} or V_{S} model may include P-wave or S-wave velocity information corresponding to a subsurface layer (e.g., layer 16 or 18) that is above the TD. The input Rho model may include density information corresponding to the subsurface layer that is above the TD. The input Q model may include attenuation information associate with one or more subsurface layers (e.g., layers 16, 18, 20, 22) around the well. The processor of the EWI-based data processing system 12 may use the input V_{P}, Rho, and Q models as starting models for an elastic waveform inversion (EWI).

At process block 103, the processor of the EWI-based data processing system 12 may calculate a reflection template. The reflection template may include waveforms corresponding to seismic waves (e.g., reflected waves 54 and 58) reflected from interfaces (e.g., interfaces 19 and 21) between adjacent subsurface layers (e.g., layers 18 and 20, layers 20 and 22). The reflection template may be generated using a modeling method (e.g., an anisotropic ray-based forward modeling) based at least in part on the input models described at process block 102.

In addition to the V_{P} model, the Rho model, and the Q model, at process block 104, the processor of the EWI-based data processing system 12 may receive VSP data. The VSP data may be acquired during a VSP survey (e.g., VSP survey 10) using seismic sensors deployed in the well (e.g., seismic sensors 36 disposed along the wireline cable 34 deployed in the borehole 32 of the well 30).

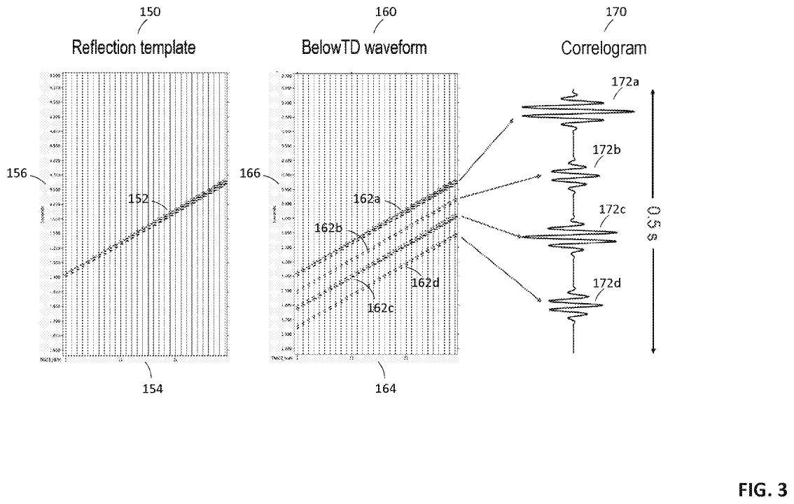

At process block 106, the processor of the EWI-based data processing system 12 may determine a number and polarities of reflections below the TD based on the VSP data and a reflection template. For example, the processor may employ a template-based searching algorithm to search waveforms in the VSP data and detect possible reflections below the TD based on a cross-correlation between the VSP data waveforms and reflection template waveforms. A resulting correlogram may indicate the number and polarities of the reflections below the TD. The template-based searching algorithm and cross-correlation method will be discussed in detail below with reference to FIG. 3.

At process block 108, the processor of the EWI-based data processing system 12 may determine a set of parameters for each reflection in a respective layer, such as depth, P-wave velocity (V_{P}) or S-wave velocity (V_{S}), density, and attenuation. For example, the processor may start a first round of grid search with the input models (e.g., the V_{P} and Rho models) associated with a first layer (e.g., a layer right above the TD). The processor may employ a grid search algorithm to determine a depth of the first layer based on a first reflection (e.g., determined based on the cross-correlation described at the process block 106) occurring at a first interface between the first layer and a second layer beneath the first layer. Furthermore, the processor may use the grid search algorithm to determine an impedance (a product of the V_{P} and Rho) of the second layer, calculate the V_{P} using a slowness of P-wave phase move-out, and decouple the impedance to obtain the Rho.

The grid search algorithm may apply to the depth, the velocity, or the density for each layer. For example, a grid search for the depth may search for a particular depth (e.g., corresponding to a travel time determined based on a correlogram generated using the cross-correlation between the VSP data and reflection template) in a gridded depth range (e.g., a depth range having 11 discrete depths: 3000 meters, 3100 meters, 3200 meters, . . . 3900 meters, and 4000 meters). Similarly, a grid search for the velocity (e.g., P-wave velocity (V_{P})) may search for a particular velocity in a gridded velocity range (e.g., a velocity range having 11 discrete velocities: 2000 m/s, 2100 m/s, 2200 m/s, . . . 2900 m/s, and 3000 m/s), and a grid search for the density (Rho) may search for a particular density in a gridded density range (e.g., a density range having 6 discrete densities: 2000 kg/m³, 2200 kg/m³, 2400 kg/m³, 2600 kg/m³, 2800 kg/m³, and 3000 kg/m³).

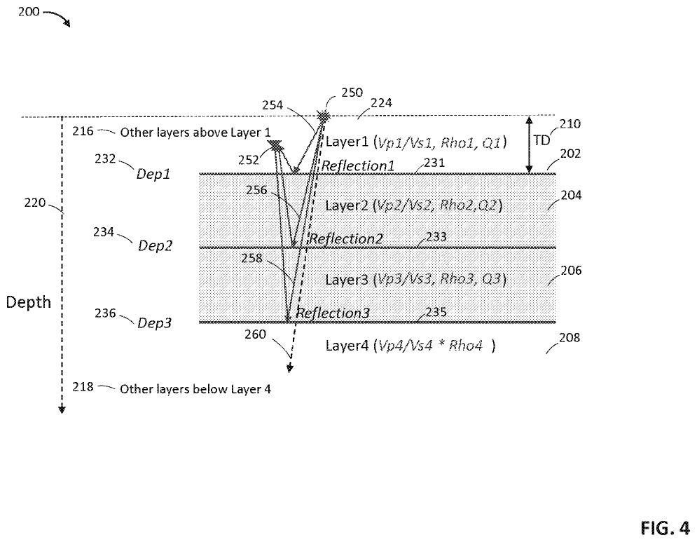

Similarly, the processor of the EWI-based data processing system 12 may repeat the grid search for the subsequent layers below the first layers. For example, the processor may start a second round of grid search with the depth of the first layer and the impedance of the second layer to determine a depth of the second layer based on a second reflection occurring at a second interface between the second layer and a third layer beneath the second layer. Furthermore, the processor may use the grid search algorithm to determine an impedance of the third layer based on the second reflection (e.g., an amplitude of the second reflection). The processor may continue the grid search by iterating through some or all the possible layers (e.g., the number of layers may be determined by the number of reflections detected) from shallow layers to deeper layers. The grid search and a method for decoupling the impedance for each layer will be discussed in detail below with reference to FIG. 4.

At the end of each round of grid search, the processor of the EWI-based data processing system 12 may determine whether a new round of grid search is needed for a next layer beneath the current later. For example, after the second round of grid search, at process block 110, the processor may determine whether the third layer beneath the second layer is need for a third round of grid search. If the number of reflections determined (at process block 106) is 3, the processor may continue the grid search (e.g., similar to actions at process block 108) for the third layer to determine a depth of the third layer and an impedance of a fourth layer beneath the third layer.

In a different example, after the second round of grid search, at process block 110, the processor determines that the number of reflections is 2 (at process block 106), which is less than the current layer number 3 (corresponding to the third layer), the processor may determine no possible (or detectable) reflection below the second layer. Therefore, the processor may stop the grid search for the third layer and start fine tuning the parameters obtained (e.g., depth, velocity V_{P} or V_{S}, density Rho, attenuation Q) for the first and the second layers.

At process block 112, the processor of the EWI-based data processing system 12 may invert the set of parameters for each layer using a downhill simplex algorithm simultaneously. As mentioned above, the set of parameters to be inverted is determined at the process block 108. The downhill simplex algorithm may be referred to as a numerical method used to find the minimum or maximum of an objective function in a multidimensional space (e.g., a multi-layer space as described above). The downhill simplex algorithm is a direct search method (e.g., based on function comparison) and is often applied to nonlinear optimization problems for which derivatives may not be known.

For example, the processor of the EWI-based data processing system 12 may employ the downhill simplex algorithm to determine if a data misfit converges. The data misfit may include a misfit between a preceding velocity value and the current velocity value and a misfit between a preceding density value and the current density value in an iterated inversion process (e.g., governed by an objection function). The processor may continue the inversion process to update (or fine tune) the velocity V_{P} or V_{S}, density Rho, and attenuation Q for all layers simultaneously, until the data misfit reaches a predetermined threshold. That is, when the data misfit reaches the threshold, the processor may no longer improve the accuracy of the inverted parameters (e.g., velocity V_{P} or V_{S}, density Rho, attenuation Q). Additionally, the processor may use the downhill simplex algorithm to adjust waveform fitting to improve the inverted parameters for each layer.

After the parameter inversion is completed for all the layers, at process block 114, the processor of the EWI-based data processing system 12 may generate an output depth model, an output V_{P} model, and an output Rho model. The output depth, V_{P}, and Rho models may include depth, V_{P}, and Rho information for each layer having a respective reflection determined at the process block 106.

FIG. 3 depicts an example reflection search process used in the EWI workflow 100 of FIG. 2 based on cross-correlations between template reflection waveforms and VSP data waveforms. A plot 150 illustrates the template reflection waveforms 152 used by the template-based searching algorithm (e.g., as described above at the process block 106 of FIG. 2) to detect possible reflections below a total depth (TD) of a well (e.g., the TD 38 of the well 30 of FIG. 1). In the plot 150, a horizontal axis 154 corresponds to numbers (e.g., trace label number) of seismic traces plotted in the plot 150, and a vertical axis 156 corresponds to time (in second) indicating travel times of corresponding template reflection waveforms 152.

In an embodiment, a processor (e.g., the processor 86) of the EWI-based data processing system 12 may employ a viscoelastic waveform inversion (VWI) to invert 1D velocity (e.g., P-wave velocity (V_{P}) or S-wave velocity (V_{S})) and attenuation (Q) models and source parameters (e.g., source wavelets) above the TD using the vertical seismic profile (VSP) data. For example, the processor may employ a ray-based waveform computation and combine objective functions of time residuals and L2 norm of waveforms. The inversion may depend on both local search (e.g., simplex search) and global search (e.g., grid search) to solve in a robust manner and within reasonable computation time. Attenuation (Q) profile may be expressed as a polynomial function to constrain the inversion. To mitigate strong trade-offs among the seismic velocity (V_{P} or V_{S}), attenuation (Q), and source parameters, the processor may use a multiple-stage procedure to update the V_{P} (or V_{S}), Q, and source parameters iteratively. The VWI result (e.g., the template reflection waveforms 152) may be used in subsequent VSP data processing.

A plot 160 illustrates the VSP data waveforms, including waveforms 162a, 162b, 162c, and 162d, respectively. The VSP data waveforms 162a-162d may be recorded in the VSP data during a VSP survey (e.g., the VSP survey 10 in the area 14 of FIG. 1). The VSP data waveforms may indicate possible reflections occurred at multiple interfaces between adjacent layers. For example, the waveforms 162a, 162b, 162c, and 162d may indicate 4 possible reflections respectively. In the plot 160, a horizontal axis 164 corresponds to numbers (e.g., trace label number) of seismic traces plotted in the plot 160, and a vertical axis 166 corresponds to time (in second) indicating travel times of corresponding VSP data waveforms 162a-162d.

As mentioned above (e.g., at process block 106 of FIG. 2), the processor of the EWI-based data processing system 12 may employ the template-based searching algorithm to detect possible reflections below the TD of the well based on a cross-correlation between the VSP data and reflection template. A resulting correlogram may indicate the number and polarities of the reflections below the TD. A plot 170 illustrates a correlogram including four group of wavelets 172a, 172b, 172c, and 172d, each indicating a detected reflection occurred at an interfaces between two adjacent layers. The processor may compute cross-correlation coefficients by cross-correlating the template reflection waveforms 152 in the plot 150 with the VSP data waveforms 162a-162d in the plot 160. Based on the cross-correlation coefficients, the processor may generate the correlogram in the plot 170. The processor may use amplitude and/or polarity information of the wavelets 172a, 172b, 172c, and 172d to determine certain parameters (e.g., impedance) of four subsurface layers in which the four detected reflections occurred. The plot 170 uses the same time scale (e.g., matching the vertical axis 156 or 166) as the plots 150 and 160. As illustrated, the correlogram includes the four group of wavelets 172a, 172b, 172c, and 172d in a time period around 0.5 second.

FIG. 4 depicts a schematic diagram of a multi-layer subsurface structure 200 that may be used to illustrating an example parameter inversion process used in the EWI workflow 100 of FIG. 2. The multi-layer subsurface structure 200 includes layers 202 (Layer1), 204 (Layer2), 206 (Layer3), and 208 (Layer4), each having different properties (e.g., depth, velocities, density, attenuation). In present example, the layer 202 is the bottom layer above a total depth (TD) 210 of a well. The well may be drilled downward through one or more other layers 216 (above the layer 1) and ended at the layer 1. The layers 204, 206, and 208 are below the TD 210. One or more other layers 218 may locate under the layer 208.

An axis 220 corresponding to depth is used to indicate depth locations of each layers described above. The depth may be measured with respect to a reference depth 224. Interfaces 231, 233, and 235 are used to specify boundaries between the layers 202 and 204, layers 204 and 206, and layers 206 and 208, respectively. The interfaces 231, 233, and 235 may have corresponding depths 232 (Dep1), 234 (Dep2), and 236 (Dep3), respectively. Different layers may have different velocities (e.g., P-wave velocities (V_{P}) or S-wave velocities (V_{S})), densities (Rho), and attenuations (Q). For example, the layers 202, 204, 206, and 208 may have V_{P1} (or V_{S1}), Rho₁, and Q₁, V_{P2} (or V_{S2}), Rho₂, and Q₂, V_{P3} (or V_{S3}), Rho₃, and Q₃, V_{P4} (or V_{S4}) and Rho₄, respectively.

A seismic source 250, positioned close to a wellbore and directly above a seismic sensors 252 (or sensor array), may be activated to generate seismic waves 254 traveling downward into the layers 202. When the seismic waves 254 arrives at the interface 231 between the layers 202 and 204, a portion of seismic energy is reflected by the interface 231 (referred to as Reflection1) and arrives at the seismic sensor 252, where it is measured by the seismic sensor 252 and recorded into VSP data. Another portion of the seismic energy contained in transmitted seismic waves 256 propagated through the layer 204 and arrives at the interface 233 between the layers 204 and 206. A portion of seismic energy is reflected by the interface 233 (referred to as Reflection2) and arrives at the seismic sensor 252, where it is measured by the seismic sensor 252 and recorded into the VSP data. Again, a different portion of the seismic energy contained in transmitted seismic waves 258 propagated through the layer 206 and arrives at the interface 235 between the layers 206 and 208. A portion of seismic energy is reflected by the interface 235 (referred to as Reflection4) and arrives at the seismic sensor 252, where it is measured by the seismic sensor 252 and recorded into the VSP data. The rest of the seismic energy contained in transmitted seismic waves 260 continuously propagated into the layer 208 and the one or more other layers 218 below the layer 208.

With this in mind, a processor (e.g., the processor 86) of the EWI-based data processing system 12 may use a grid search algorithm determine a set of parameters ((Dep1, V_{P1} or V_{S1}, Rho1, and Q₁), (Dep2, V_{P2} or V_{S2}, Rho2, and Q₂), (Dep3, V_{P3} or V_{S3}, Rho3, and Q₃), and so on) for each reflection (Reflection1, Reflection2, Reflection3, and so on) in a respective layer (Layer1, Layer2, Layer3, and so on). For example, the grid search algorithm may start a first round of grid search with V_{P1} and Rho1 of the Layer1. Based on the first reflection (Reflection1), the grid search algorithm may search the depth (Dep1) of the Reflection1. After the Dep1 is determined, the processor may use the grid search algorithm to determine an impedance (V_{P2}*Rho2) of the Layer2 below the Layer1 based on the Reflection1. As mentioned above, the Reflection1 may be determined based on the amplitude of Reflection1 using the cross-correlation between the VSP data and reflection template, as described in FIG. 3. To decouple the impedance (V_{P2}*Rho2) of the Layer2, the grid search algorithm may infer the V_{P2} from a slowness (a reciprocal of P-wave velocity) of the Reflection2.

The processor of the EWI-based data processing system 12 may apply the similar process to the layers below the Layer2 to search the Dep2 of the Reflection2, and V_{P3}, and Rho3 of Layer3, until the last reflection (determined based on the cross-correlation between the VSP data and reflection template, as described in FIG. 3). In present example, the last reflection is Reflection3 occurred on the interface 235. In the last reflection, the Dep3 of the Reflection3 and an impedance (V_{P4}*Rho4) of the Layer4 may be calculated. However, because no further reflection below is detectable (based on the cross-correlation described in FIG. 3), V_{P4} may not be decoupled from the Rho4 using the impedance of the Layer4.

Although the example described above includes P-wave velocity (e.g., V_{P1}, V_{P2}, V_{P3}) inversions for each subsurface layers, it should be understood that the method may be performed in S-wave velocity (e.g., V_{S1}, V_{S2}, V_{S3}) inversions for each subsurface layers.

The attenuation Q may change the shape of the waveforms along the wave travel distance. Traveling in attenuated medium may distort waveform phase, dump waveform amplitude, and broaden the phase duration, which may be different from the effect of velocity and density. In one embodiment, the processor of the EWI-based data processing system 12 search the best Q value (e.g., Q₁, Q₂, Q₃), for each layer (Layer1, Layer2, Layer3) to best match the waveform shapes.

Once the grid search for each reflection is done, the processor of the EWI-based data processing system 12 may invert the set of parameters for all layers (e.g., Layer1, Layer2, and Layer3) using a downhill simplex algorithm simultaneously. For example, the processor may employ the downhill simplex algorithm to fine tune the set of parameters for all layers, such as the V_{P2} or V_{S2}, Rho2, and Q₂ for the Layer2, the V_{P3} or V_{S3}, Rho3, and Q₃ for the Layer3. The processor may use the downhill simplex algorithm to determine if a data misfit converges and continue the inversion process until the data misfit reaches a predetermined threshold. In some embodiments, the processor may use the downhill simplex algorithm to adjust waveform fitting to improve the inverted parameters for each layer.

After the simultaneous parameter inversion using the downhill simplex algorithm is completed for all the layers, the processor of the EWI-based data processing system 12 may output the inverted parameters in corresponding output models, such as an output depth model (including Dep1, Dep2, Dep3), an output V_{P} model (including V_{P1}, V_{P2}, V_{P3}) or V_{S} model (including V_{S1}, V_{S2}, V_{S3}), an output Rho model (including Rho1, Rho2, Rho3), and an output Q model (including Q₁, Q₂, Q₃).

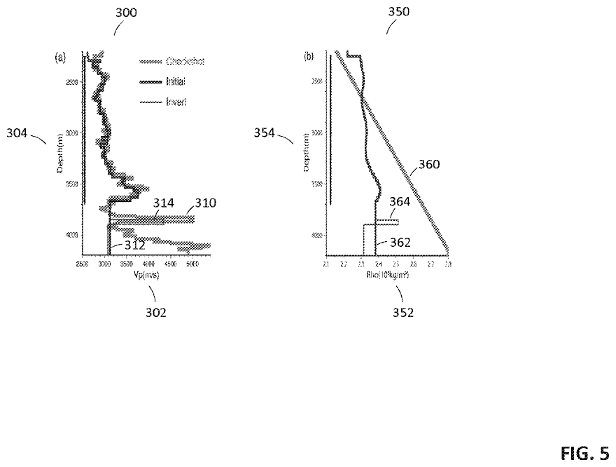

FIG. 5 depicts examples of inversion results using the EWI workflow 100 of FIG. 2. The examples of inversion results may include inverted P-wave velocity (V_{P}) or S-wave velocity (V_{S}) and density (Rho) models with comparisons to reference data (e.g., data not used in the velocity model building, such as check shots) and initial models used for the elastic waveform inversion. The check shot models may be derived from borehole seismic data designed to measure the seismic travel time from a surface to a known depth. The check shot models may be used to compare or calibrate the other models (e.g., V_{P} and Rho models).

A plot 300 illustrates three P-wave velocity (V_{P}) curves 310, 312, and 314, representing a check shot velocity model, an initial velocity model used at the beginning of the EWI, and the inverted velocity model after the EWI, respectively. An axis 302 indicates V_{P} values (in meters per second) for each velocity cures. An axis 304 indicates the depth values (in meters) for each velocity cures. A comparison between the V_{P} curves 312 and 314 shows the velocity updates (e.g., at around 3900 meter) via the EWI. Another comparison between the V_{P} curves 310 and 314 shows the matches of the V_{P} between the check shot velocity model and the inverted velocity model.

A plot 350 illustrates three density (Rho) curves 360, 362, and 364, representing a check shot density model, an initial density model used at the beginning of the EWI, and the inverted density model after the EWI, respectively. An axis 352 indicates Rho values (in 103 kilograms per cubic meter) for each density cures. An axis 354 (that matches the axis 304 in the plot 300) indicates the depth values (in meters) for each density cures. A comparison between the Rho curves 362 and 364 shows the density updates (e.g., at around and below 3900 meter) via the EWI. Another comparison between the Rho curves 360 and 364 shows the differences of the Rho between the check shot density model and the inverted density model.

The systems and methods described in present disclosure provide a robust elastic waveform inversion with reasonable computation time. The elastic waveform inversion utilizes a template-based searching technique to detect possible reflections below a total depth (TD) of a well. The elastic waveform inversion uses a relative accurate medium model (including velocity and density information) above the TD derived from a viscoelastic waveform inversion, and extends (or updates) the medium model to below the TD. The elastic waveform inversion cross-correlates template reflection waveforms generated from an anisotropic ray-based forward modeling with vertical seismic profile (VSP) data to output a correlogram, which indicates detectable reflections in the VSP data. Based on the detectable reflections, the elastic waveform inversion use a grid search algorithm to determines a set of parameters for each reflection in a respective layer, such as depth, P-wave velocity (V_{P}) or S-wave velocity (V_{S}), density (Rho), and attenuation (Q). The elastic waveform inversion continues the grid search by iterating through all the possible layers until the last reflection. After the grid search for all the reflections completes, the elastic waveform inversion inverts the set of parameters for all layers or a subset of the layers using a numerical algorithm (e.g., a Nelder-Mead algorithm such as a downhill simplex algorithm) simultaneously. For example, the downhill simplex algorithm may be used to find a minimum or a maximum of an objective function in a multidimensional space. Once the simultaneous parameter inversion completes for all the layers, the elastic waveform inversion outputs the inverted parameters in corresponding output models (e.g., V_{P} and Rho models).

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A system, comprising:
a memory configured to store at least a template-based search algorithm, a grid search algorithm, and a downhill simplex algorithm;
one or more processors configured to:
receive a plurality of input models associated with a subsurface layer above a total depth of a well;
calculate a reflection template based at least in part on the plurality of input models;
receive vertical seismic profile (VSP) data acquired at the well;
employ the template-based searching algorithm to detect a plurality of reflections below the total depth of the well, wherein the plurality of reflections are associated with the subsurface layer and a plurality of subsequent subsurface layers below the subsurface layer;
based on the plurality of reflections, employ the grid search algorithm to determine a depth of the subsurface layer and a set of parameters associated with the plurality of subsequent subsurface layers;
employ the downhill simplex algorithm to invert the set of parameters for the plurality of subsequent subsurface layers simultaneously; and
generate a plurality of output models comprising the set of parameters being inverted.

2. The system of claim 1, wherein the plurality of input models comprises an input P-wave or S-wave velocity model, an input density model, and an input attenuation model associated with the subsurface layer.

3. The system of claim 2, wherein the plurality of input models is generated based on a viscoelastic waveform inversion (VWI) using the VSP data.

4. The system of claim 1, wherein the reflection template comprises waveforms corresponding to seismic waves reflected by the subsurface layer and the plurality of subsequent subsurface layers, wherein the waveforms are generated using an anisotropic ray-based forward modeling.

5. The system of claim 1, wherein the VSP data is acquired by a plurality of seismic sensors deployed in a borehole of the well and configured to detect seismic waves initiated from one or more seismic sources and reflected by the subsurface layer and the plurality of subsequent subsurface layers, wherein the one or more seismic sources are deployed close to a wellbore of the well and directly above the plurality of seismic sensors.

6. The system of claim 1, wherein the set of parameters comprise a depth, a P-wave or S-wave velocity, a density, and an attenuation of each subsequent subsurface layer of the plurality of subsequent subsurface layers.

7. The system of claim 1, wherein the template-based searching algorithm comprises a cross-correlation between the VSP data and reflection template.

8. The system of claim 1, wherein the grid search algorithm comprises searching the depth of the subsurface layer based on a first reflection of the plurality of reflections.

9. The system of claim 8, wherein the grid search algorithm comprises determining an impedance of a first subsequent subsurface layer of the plurality of subsequent subsurface layers based on the depth of the subsurface layer and the first reflection of the plurality of reflections.

10. The system of claim 9, wherein the grid search algorithm comprises decoupling the impedance into a P-wave or S-wave velocity and a density of the first subsequent subsurface layer of the plurality of subsequent subsurface layers, wherein decoupling the impedance comprises using a slowness of P-wave phase move-out.

11. The system of claim 10, wherein the grid search algorithm comprises an iteration process for determining a respective depth and a respective impedance of one or more subsequent subsurface layers of the plurality of subsequent subsurface layers, wherein the one or more subsequent subsurface layers are below the first subsequent subsurface layer.

12. The system of claim 11, wherein the iteration process stops at a subsequent subsurface layer associated with a last reflection of the plurality of reflections.

13. A method, comprising:
receiving a plurality of input models associated with a subsurface layer above a total depth of a well;
calculating a reflection template based at least in part on the plurality of input models;
receiving vertical seismic profile (VSP) data acquired at the well;
determining a number and polarities of a plurality of reflections below the total depth of the well based on the vertical seismic profile (VSP) data and the reflection template, wherein the plurality of reflections are associated with the subsurface layer and a plurality of subsequent subsurface layers below the subsurface layer;
determining a depth of the subsurface layer and a set of parameters associated with the plurality of subsequent subsurface layers based on the plurality of reflections;
inverting the set of parameters for the plurality of subsequent subsurface layers simultaneously; and
generating a plurality of output models comprising the set of parameters being inverted.

14. The method of claim 13, wherein the plurality of input models is indicative of a plurality of characteristics associated with the subsurface layer, and wherein the plurality of characteristics comprises P-wave or S-wave velocity, density, and attenuation information associated with the subsurface layer.

15. The method of claim 13, wherein determining the number and polarities of the plurality of reflections comprises employing a template-based searching algorithm to detect the plurality of reflections.

16. The method of claim 13, wherein determining the depth of the subsurface layer and the set of parameters comprises employing a grid search algorithm.

17. The method of claim 13, wherein inverting the set of parameters simultaneously comprises employing a downhill simplex algorithm.

18. A non-transitory computer-readable medium comprising instructions that, when executed by one or more processors, cause the one or more processors to:
receive a plurality of input models associated with a subsurface layer above a total depth of a well;
receive vertical seismic profile (VSP) data acquired at the well;
calculate a reflection template based at least in part on the plurality of input models;
detect a plurality of reflections below the total depth of the well, wherein the plurality of reflections are associated with the subsurface layer and a plurality of subsequent subsurface layers below the subsurface layer;
determine a number and polarities of the plurality of reflections based on the vertical seismic profile (VSP) data and the reflection template;
determine a depth of the subsurface layer and a set of parameters associated with the plurality of subsequent subsurface layers based on the plurality of reflections;
invert the set of parameters for the plurality of subsequent subsurface layers simultaneously; and
generate a plurality of output models comprising the set of parameters being inverted.

19. The non-transitory computer-readable medium of claim 18, comprising the instructions that, when executed by the one or more processors, cause the one or more processors to implement a plurality of algorithms comprising:
a template-based searching algorithm configured to:
detect the plurality of reflections;
determine the number and polarities of the plurality of reflections based on the plurality of reflections;
search the depth of the subsurface layer based on a first reflection of the plurality of reflections;
determine an impedance of a first subsequent subsurface layer of the plurality of subsequent subsurface layers based on the depth of the subsurface layer and the first reflection of the plurality of reflections;
decouple the impedance into a P-wave or S-wave velocity and a density of the first subsequent subsurface layer of the plurality of subsequent subsurface layers; and
determine a respective depth and a respective impedance of one or more subsequent subsurface layers of the plurality of subsequent subsurface layers below the first subsequent subsurface layer.
a grid search algorithm configured to determine the depth of the subsurface layer and the set of parameters; and
a downhill simplex algorithm configured to invert the set of parameters simultaneously.

20. The non-transitory computer-readable medium of claim 19, wherein the plurality of output models comprises a P-wave or S-wave velocity model, a density model, an attenuation model, and the respective depth of one or more subsequent subsurface layers of the plurality of subsequent subsurface layers.
